(19) United States
(12) Patent Application Publication
(10) Pub. No.: US 2026/0243871 A1
(43) Pub. Date: Aug. 20, 2026

(54) METHOD, DEVICE, AND COMPUTER-READABLE STORAGE MEDIUM FOR PLANNING SCANNING PATH OF FREQUENCY-MODULATED LIGHT DETECTION AND RANGING (LIDAR) SCANNER

(71) Applicant: BEIJING AEROSPACE INSTITUTE FOR METROLOGY AND MEASUREMENT TECHNOLOGY, Beijing (CN)

(72) Inventors: Chenxing BAO, Beijing (CN); Yinxiao MIAO, Beijing (CN); Tianmao GUO, Beijing (CN); Hao ZHU, Beijing (CN); Kailei WANG, Beijing (CN); Xiaoguang WANG, Beijing (CN); Xiao TENG, Beijing (CN); Haicun ZHANG, Beijing (CN); Yi YANG, Beijing (CN); Xingyu WANG, Beijing (CN)

(21) Appl. No.: 19/648,006

(22) Filed: Apr. 15, 2026

(30) Foreign Application Priority Data
Jun. 10, 2025 (CN) 202510765194.2

(51) Int. Cl. G01S 7/481; G01S 17/42

(52) U.S. Cl. CPC G01S 7/4817; G01S 17/42

(57) ABSTRACT

A method for planning a scanning path of a frequency-modulated LiDAR scanner, in which multiple boundary points of a polygonal scanning region are defined; a boundary direction is standardized; a scanning direction is defined by determining an included angle α between a movement direction of a measurement light spot and an X-axis; a scan line spacing is defined; a scanning starting point is determined; a control point sequence is generated; and the control points is rotated by an angle of −α about a centroid of the boundary points to output final path control points. An electronic device and a computer-readable storage medium for performing such method are further provided.

### CROSS-REFERENCE TO RELATED APPLICATIONS

This application claims the benefit of priority from Chinese Patent Application No. 202510765194.2, filed on Jun. 10, 2025. The content of the aforementioned application, including any intervening amendments thereto, is incorporated herein by reference in its entirety.

### TECHNICAL FIELD

This application relates to the field of precise measurement technologies, and more particularly to a method, an electronic device, and a computer-readable storage medium for planning a scanning path of a frequency-modulated light detection and ranging (LiDAR) scanner.

### BACKGROUND

A frequency-modulated LiDAR scanner is a non-contact, large-scale and high-precision three-dimensional measurement instrument, which can acquire three-dimensional coordinates of measured points in a polar coordinate system through high-precision distance measurement and two-dimensional high-precision angle measurement. In practical engineering applications, the frequency-modulated LiDAR scanner performs scanning measurements for a specified region in accordance with a predetermined scanning direction and spacing, thereby generating a three-dimensional point cloud representing a surface of an object under measurement. When a specified three-dimensional spatial region is projected into a measurement coordinate system of the frequency-modulated LiDAR scanner, the projected region forms an arbitrary two-dimensional polygon. Efficiently planning a uniform scanning path for an arbitrary two-dimensional polygon in accordance with a specified scanning direction presents a significant technical challenge. FIG. 1 is a schematic diagram illustrating a scanning path planning for a polygonal region in the prior art. However, in the prior art, projecting a user-specified three-dimensional spatial region into the LiDAR measurement coordinate system often results in a two-dimensional polygon with a complex boundary, thereby presenting a key technical difficulty. The prior art lacks a general-purpose and efficient path planning method capable of rapidly and accurately generating a uniform scanning path that conforms to a specified scanning direction (i.e., a movement direction of a measurement light spot) and satisfies a predetermined scan spacing for a polygonal region of arbitrary shape and arbitrary direction. The absence of such a path planning capability reduces the operational efficiency and limits adaptability of the frequency-modulated LiDAR scanner in complex and irregular scenarios. Accordingly, there is a need for a scanning path planning method that enables efficient and uniform scanning measurement for a polygonal region of arbitrary shape and arbitrary direction.

### SUMMARY

In view of the foregoing, the present disclosure provides a method, an electronic device, and a computer-readable storage medium for planning a scanning path of a frequency-modulated LiDAR scanner. The method disclosed herein enables scanning path planning for a designated spatial polygonal region of arbitrary shape, thereby achieving rapid scanning measurement for an arbitrary region in an arbitrary direction.

In order to achieve the above objectives, the present disclosure provides a method for planning a scanning path of a frequency-modulated LiDAR scanner, which includes the following steps:
(S1) defining a plurality of boundary points of a polygonal scanning region; sequentially recording coordinates (x, y) of the plurality of boundary points; sequentially connecting the plurality of boundary points to define a closed region S; and denoting a contour of the closed region S as a contour E;
(S2) standardizing a boundary direction, comprising:
   calculating a centroid of the plurality of boundary points;
   determining a rotation direction of the plurality of boundary points; and
   when the plurality of boundary points are in a counterclockwise direction, reversing an order of the plurality of boundary points to convert the rotation direction into a clockwise direction;
(S3) defining a scanning direction, comprising: determining an included angle α between a movement direction of a measurement light spot and an X-axis;
(S4) defining a scan line spacing Δy;
(S5) determining a scanning starting point, comprising:
   rotating the plurality of boundary points by the angle α about the centroid to obtain rotated boundary points;
   selecting one among the rotated boundary points having a minimum y-coordinate as the scanning starting point (xₒ, yₒ); wherein if there are two or more rotated boundary points among the rotated boundary points sharing the minimum y-coordinate, one of the two or more rotated boundary points having a minimum x-coordinate is selected as the scanning starting point (x0, y0) and
(S6) generating a sequence of control points, comprising:
   drawing a plurality of straight lines parallel to the X-axis according to y=yₒ+N·Δy, wherein N=0, 1, 2, . . . ;
   determining a set I of a plurality of intersection points between the plurality of straight lines and the contour E;
   when a number of the plurality of intersection points in the set I is an even number, defining the plurality of intersection points in the set I as the control points;
   when the number of the plurality of intersection points in the set I is an odd number, removing an intersection point coincident with a corresponding one of the plurality of boundary points from the set I, and defining remaining intersection points in the set I as the control points;
   when N is an even number, sorting the control points in an ascending order according to x-coordinates of the control points; and
   when N is an odd number, sorting the control points in a descending order according to the x-coordinates of the control points; and
(S7) rotating the control points by an angle of −α about the centroid to generate path control points.

In the embodiments of the present disclosure, at step (S1), in the closed region, any two connecting line segments do not intersect with each other.

In the embodiments of the present disclosure, at step (S3), the included angle α satisfies 0°≤α<360°.

In the embodiments of the present disclosure, at step (S6), removing the intersection point coincident with a corresponding one of the plurality of boundary points from the set I comprises: identifying, among the plurality of intersection points, a point having coordinates identical to coordinates of a corresponding one of the plurality of rotated boundary points; and removing the point from the set I.

In the embodiments of the present disclosure, at step (S6), sorting according to the x-coordinates is implemented through a quick sort algorithm.

The present disclosure further provides an electronic device. The electronic device, comprising:
a processor; and
a memory storing an executable instruction thereon; wherein the processor is configured to read and execute the executable instruction to perform the method according to any one of the above embodiments.

The present disclosure further provides a non-transitory computer-readable storage medium. The non-transitory computer-readable storage medium storing a computer program which, when executed by a processor, causes the processor to perform the method according to any one of the above embodiments.

The present disclosure provides the following beneficial effects:
1. The method enables scanning path planning for a polygonal region of arbitrary shape and arbitrary direction, thereby allowing the LiDAR scanner to operate effectively in complex application scenarios. Specifically, by defining boundary points and standardizing the rotation direction (steps S1-S2), polygonal regions of arbitrary shapes, including both concave and convex polygons, may be processed, thereby overcoming limitations of conventional methods that are restricted to regular shapes.
2. The method introduces a rotated coordinate system in which an arbitrary scanning direction α is converted into a vertical-direction processing scheme. The control points are subsequently restored through inverse rotation, thereby enabling full 360° configurability of the scanning direction and satisfying multi-angle measurement requirements.
3. The method introduces an odd-intersection-point handling mechanism. When a scan line coincides with a boundary point, a coincident intersection point is automatically removed, thereby preventing path interruption or duplicate scanning and ensuring continuity and integrity of the scan lines.
4. The method adopts a serpentine path planning strategy in which control points of even-numbered and odd-numbered scan lines are sorted in opposite directions (i.e., ascending or descending with respect to x-coordinate), thereby forming a continuous reciprocating path, reducing idle travel of a laser head, and improving scanning efficiency by more than 30%.
5. By utilizing centroid-based rotational consistency control and a constant scan line spacing Δy, the method achieves a substantially uniform distribution of measurement point clouds across an entire region, avoids data sparsity near boundaries, and improves three-dimensional reconstruction accuracy.
6. The algorithm employed in the method requires only fundamental geometric operations, including rotation, intersection computation, and sorting, without reliance on GPU acceleration or specialized hardware. Accordingly, the method can be executed in real time within an embedded LiDAR system, and can automatically output the scanning path for the scanner, significantly reducing the engineering costs.

### BRIEF DESCRIPTION OF THE DRAWINGS

FIG. 1 is a schematic diagram illustrating a scanning path planning for a polygonal region in the prior art.

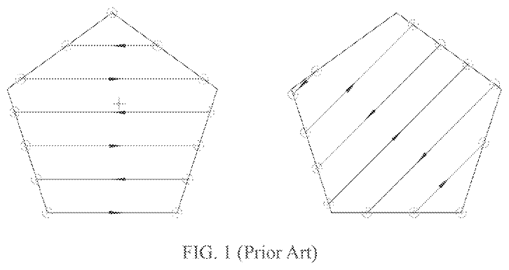

FIG. 2 is a flow chart of a method according to the embodiments of the present disclosure.

FIG. 3 is a flow chart illustrating a control point planning process according to the embodiments of the present disclosure.

FIG. 4 is a schematic diagram illustrating arbitrary polygonal scanning regions according to the embodiments of the present disclosure.

FIG. 5 is a schematic diagram illustrating planned control points according to the embodiments of the present disclosure.

FIG. 6 is a schematic diagram of an electronic device according to the embodiments of the present disclosure.

### DETAILED DESCRIPTION OF EMBODIMENTS

The present disclosure will be described in detail below with reference to the accompanying drawings and specific embodiments.

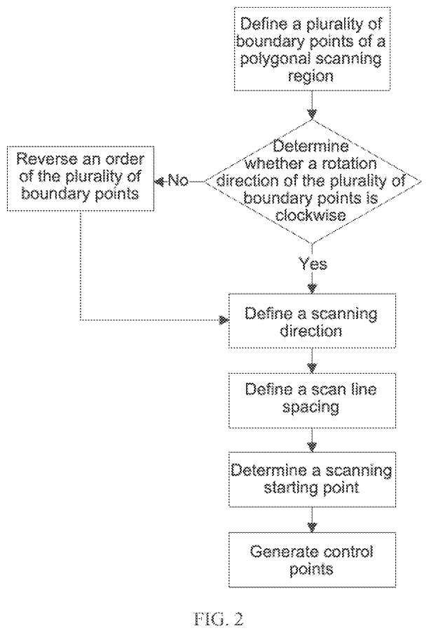

The present disclosure provides a method for planning a scanning path of a frequency-modulated light detection and ranging (LiDAR) scanner. First, a set of boundary points is defined to form a polygonal scanning region. A scanning direction and a scan line spacing are then defined. A scanning starting point is subsequently determined, and path control points are generated accordingly. The process is illustrated in FIG. 2 and includes the following steps.

In some embodiments, the scanning path is generated from the path control points, and the scanner can move a light spot along the scanning path to perform scanning. Information of the path control points is sequentially transmitted by the host computer to the scanner, so as to control the scanner to move to individual control points in sequence, thereby completing scanning of a to-be-inspected object.

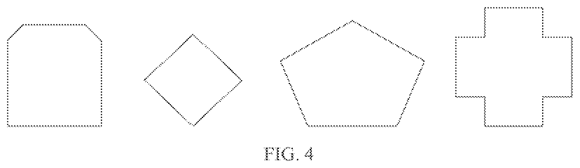

(S1) Boundary points of a polygonal scanning region are defined. Coordinates (x, y) of the boundary points of the polygonal scanning region are sequentially recorded, and the boundary points are sequentially connected to define a closed region S. For example, the closed region S may be an arbitrary polygonal scanning region as shown in FIG. 4. The closed region S represents a region to be scanned. A contour of the closed region S is denoted as E. In some embodiments of the present disclosure, all connecting line segments are required to be non-intersecting.

(S2) A rotation direction of the boundary points is determined as follows. Using a centroid of all boundary points as a center, the rotation direction of the boundary points about the centroid is determined. If the rotation direction is clockwise, no transformation is performed. If the rotation direction is counterclockwise, an order of the boundary points is reversed to convert the rotation direction into a clockwise direction.

(S3) A scanning direction is determined as follows. The scanning direction refers to a movement direction of a measurement light spot. During path planning, the scanning direction is determined by defining an included angle between the movement direction of the measurement light spot and an X-axis, and the included angle is denoted as α.

In some embodiments of the present disclosure, a positive direction may be set to be the movement direction of the measurement light spot by default.

(S4) A scan line spacing is defined as follows. The scan line spacing refers to a distance between adjacent scan lines and is denoted as Δy.

In some embodiments of the present disclosure, the scan line spacing may be configured by a host computer according to measurement requirements of a workpiece to be measured. In particular, the host computer may determine the scan line spacing based on a required measurement point density of the workpiece. When a higher point density is required, the scan line spacing may be correspondingly reduced so as to increase the number of sampled points per unit area; conversely, when a lower point density is sufficient, the scan line spacing may be increased. In this manner, the scan line spacing may be adaptively adjusted to balance measurement resolution and acquisition efficiency.

(S5) A scanning starting point is determined as follows. The boundary points are rotated by the angle α about the centroid to obtain rotated boundary points. One among the rotated boundary points having a minimum y-coordinate is selected as the scanning starting point (x0, y0); wherein if there are two or more rotated boundary points among the rotated boundary points sharing the minimum y-coordinate, one of the two or more rotated boundary points having a minimum x-coordinate is selected as the scanning starting point (x0, y0).

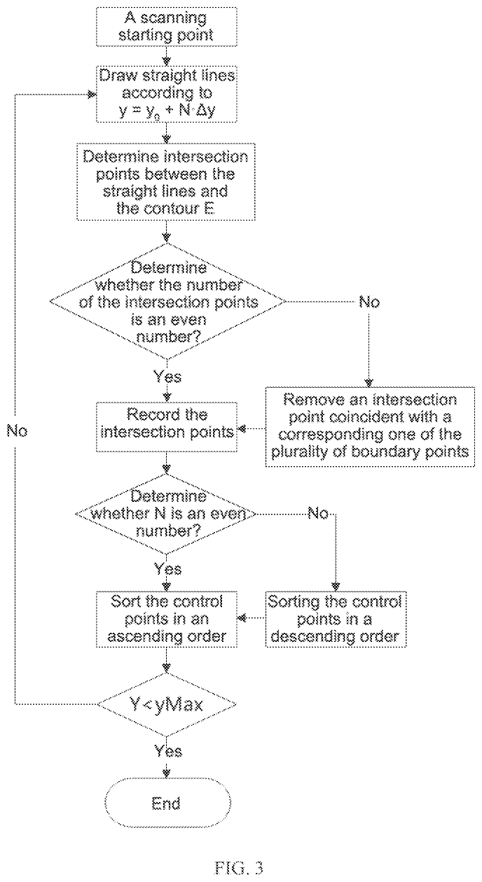

(S6) A sequence of control points is generated. A process for generating the control points is illustrated in FIG. 3 and is described as follows.

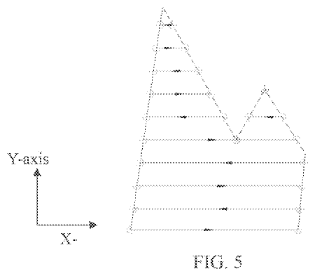

Starting from the scanning starting point, multiple straight lines parallel to the X-axis are drawn according to y=yₒ+N·Δy, where N=0, 1, 2, . . . . All intersection points between the straight line and the contour E are calculated and form a set I. When a number of the intersection points in the set I is an even number, the intersection points in the set I are defined as the control points. When the number of the intersection points in the set I is an odd number, an intersection point in the set I coincides with a corresponding one of the rotated boundary points. The coincident intersection point is removed from the set I, and remaining intersection points in the set I are defined as the control points. When N is an even number, the control points are sorted in an ascending order according to x-coordinates of the control points. When N is an odd number, the control points are sorted in a descending order according to the x-coordinates of the control points. FIG. 5 is a schematic diagram illustrating planned control points according to the embodiments of the present disclosure.

(S7) The control points are transformed as follows. All control points are rotated by an angle of −α about the centroid to generate path control points.

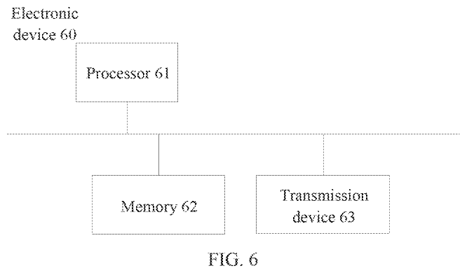

In another aspect, the present disclosure further provides an electronic device. FIG. 6 is a schematic diagram of an electronic device 60 according to the embodiments of the present disclosure. For example, the electronic device 60 includes a processor 61, a memory 62, and a transmission device 63. The processor 61 is configured to perform the method described in any one of the above embodiments. The processor 61 and the memory 62 may be connected via a bus or in other manners. A bus connection is provided as an example. The transmission device 63 may be connected to the processor 61 and the memory 62 through wired or wireless means. The memory 62 serves as a non-transitory computer-readable storage medium and may store non-transitory software programs, non-transitory computer-executable programs, and modules, such as program instructions/modules corresponding to the method for planning the scanning path of the frequency-modulated LiDAR scanner according to the embodiments of the present disclosure. The processor 61 is configured to execute various functional applications and data processing by running the software programs, instructions, and modules stored in the memory 62, thereby implementing the method described above. The memory 62 may include a program storage area and a data storage area. The program storage area may store an operating system and application programs required for at least one function. The data storage area may store data created by the processor. In addition, the memory 62 may include high-speed random access memory and may further include non-transitory memory, such as at least one magnetic disk storage device, flash memory device, or other non-transitory solid-state storage device. In some embodiments, the memory 62 may optionally include remote storage devices relative to the processor, and such remote storage devices may be connected to the processor via a network. Examples of the network include, but are not limited to, the Internet, an intranet, a local area network (LAN), a mobile communication network, and combinations thereof. One or more modules are stored in the memory 62 and, when executed by the processor 61, cause the processor 61 to perform the method for planning the scanning path of the frequency-modulated LiDAR scanner as described in the above embodiments.

In another aspect, the present disclosure further provides a computer-readable storage medium. The computer-readable storage medium may be included in the electronic device described in the above embodiments, or may exist independently without being assembled into the electronic device. The computer-readable storage medium may be a tangible storage medium, such as random-access memory (RAM), read-only memory (ROM), electrically programmable ROM, electrically erasable programmable ROM, registers, floppy disks, hard disks, removable storage disks, CD-ROMs, or any other form of storage medium known in the art. The computer-readable storage medium is configured to store one or more programs which, when executed by one or more processors, cause the one or more processors to perform the method for planning the scanning path of the frequency-modulated LiDAR scanner described in the embodiments of the present disclosure.

In summary, the foregoing embodiments are merely preferred embodiments of the present disclosure, and are not intended to limit the scope of the present disclosure. Any modifications, equivalent substitutions and improvements made within the spirit and principles of the present disclosure shall fall within the scope of the present disclosure defined by the appended claims.

What is claimed is:

1. A method for planning a scanning path of a frequency-modulated light detection and ranging (LiDAR) scanner, comprising:
(S1) defining a plurality of boundary points of a polygonal scanning region; sequentially recording coordinates (x, y) of the plurality of boundary points; sequentially connecting the plurality of boundary points to define a closed region S; and obtaining a contour E of the closed region S;
(S2) standardizing a boundary direction, comprising:
calculating a centroid of the plurality of boundary points;
determining a rotation direction of the plurality of boundary points; and
when the plurality of boundary points are in a counterclockwise direction, reversing an order of the plurality of boundary points to convert the rotation direction into a clockwise direction;
(S3) defining a scanning direction, comprising:
determining an included angle α between a movement direction of a measurement light spot and an X-axis;
(S4) defining a scan line spacing Δy;
(S5) determining a scanning starting point, comprising:
rotating the plurality of boundary points by the angle α about the centroid to obtain rotated boundary points;
selecting one among the rotated boundary points having a minimum y-coordinate as the scanning starting point (x0, y0); wherein if there are two or more rotated boundary points among the rotated boundary points sharing the minimum y-coordinate, one of the two or more rotated boundary points having a minimum x-coordinate is selected as the scanning starting point (x0, y0);
(S6) generating a sequence of control points, comprising:
drawing a plurality of straight lines parallel to the X-axis according to y=yₒ+N·Δy, wherein N=0, 1, 2, . . . ;
determining a set I of a plurality of intersection points between the plurality of straight lines and the contour E;
when a number of the plurality of intersection points in the set I is an even number, defining the plurality of intersection points in the set I as the control points;
when the number of the plurality of intersection points in the set I is an odd number, removing an intersection point coincident with a corresponding one of the plurality of boundary points from the set I, and defining remaining intersection points in the set I as the control points;
when N is an even number, sorting the control points in an ascending order according to x-coordinates of the control points; and
when N is an odd number, sorting the control points in a descending order according to the x-coordinates of the control points; and
(S7) rotating the control points by an angle of −α about the centroid to generate path control points.

2. The method according to claim 1, wherein at step (S1), in the closed region S, any two connecting line segments do not intersect with each other.

3. The method according to claim 2, wherein at step (S3), the included angle α satisfies 0°≤α<360°.

4. The method according to claim 1, wherein at step (S6), removing the intersection point coincident with the corresponding one of the plurality of boundary points from the set I comprises:
identifying, among the plurality of intersection points, a point having coordinates identical to coordinates of a corresponding one of the plurality of rotated boundary points; and
removing the point from the set I.

5. The method according to claim 4, wherein at step (S6), sorting according to the x-coordinates is implemented through a quick sort algorithm.

6. An electronic device, comprising:
a processor; and
a memory storing an executable instruction thereon;
wherein the processor is configured to read and execute the executable instruction to perform the method according to claim 1.

7. A non-transitory computer-readable storage medium storing a computer program which, when executed by a processor, causes the processor to perform the method according to claim 1.
